(19) United States
(12) Patent Application Publication
(10) Pub. No.: US 2008/0286656 A1
(43) Pub. Date: Nov. 20, 2008

(54) NEGATIVE ACTIVE MATERIAL FOR LITHIUM SECONDARY BATTERY, METHOD OF PREPARING THEREOF, AND LITHIUM SECONDARY BATTERY INCLUDING SAME

(75) Inventors: Jaephil CHO, Yongin-si (KR); Youn-Han Chang, Osan-si (KR); Jin-Young Kim, Gumi-si (KR)

Correspondence Address: LEXYOUME IP GROUP, LLC, 5180 PARKSTONE DRIVE, SUITE 175, CHANTILLY, VA, 20151, US

(73) Assignees: Kumoh National Institute of Technology Industry- Academic Cooperation, Gumi-si (KR); L & F CO., LTD., Daegu-city (KR)

(21) Appl. No.: 11/937,066

(22) Filed: Nov. 8, 2007

(30) Foreign Application Priority Data
May 15, 2007 (KR) 10-2007-0047170

(51) Int. Cl. H01M 4/58; H01M 10/00; H01M 4/62

(52) U.S. Cl. 429/231.95; 429/218.1; 429/232

(57) ABSTRACT

A negative active material for a lithium secondary battery according to an embodiment of the present invention includes a core material including an inorganic particulate that is capable of forming a compound by a reversible reaction with lithium, and a surface-treatment layer disposed on the surface of the core material. The surface-treatment layer includes a metal having electronic conductivity of 10³ S/cm or more. The negative active material can improve high-rate performance of a lithium secondary battery.

### CROSS-REFERENCE TO RELATED APPLICATION

This application claims priority to and the benefit of Korean Patent Application No. 10-2007-0047170 filed in the Korean Intellectual Property Office on May 15, 2007, the entire contents of which are incorporated herein by reference.

### BACKGROUND OF THE INVENTION

(a) Field of the Invention

The present invention relates to a negative active material for a lithium secondary battery, a method of preparing the same, and a lithium secondary battery including the same. More particularly, the present invention relates to a negative active material for a lithium secondary battery that is capable of improving rate-capability of a battery, a method of preparing the same, and a lithium secondary battery including the same.

(b) Description of the Related Art

In recent times, due to reduction in size and weight of portable electronic equipment, there has been a need to develop batteries used for the portable electronic equipment that have both high performance and large capacity.

Batteries generate electric power by using materials that are capable of electrochemical reactions at positive and negative electrodes. For example, a rechargeable lithium battery generates electricity due to change of chemical potentials when lithium ions are intercalated/deintercalated at positive and negative electrodes.

The rechargeable lithium battery includes a material that can reversibly intercalate/deintercalate lithium ions as positive and negative active materials, and an organic electrolyte solution or a polymer electrolyte charged between the positive and negative electrodes.

In general, a rechargeable lithium battery includes a lithium composite metal compound as a positive active material. For example, LiCoO₂, LiMn₂O₄, LiNiO₂, LiNi₁₋ₓCoₓO₂ (0<x<1), LiMnO₂, and the like have been researched.

In addition, a negative active material includes various types of carbon-based materials that can intercalate/deinteralate lithium, such as artificial graphite, natural graphite, and hard carbon. However, when a substrate is made of graphite such as artificial graphite or natural graphite as an active material among the carbon-based materials, it may have a problem of low density and thereby low capacity in terms of energy density per unit volume.

Accordingly, metal-based or intermetallic compound-based materials are being actively researched as a negative active material.

Japanese Patent Laid-Open No. Pyung 10-223221 discloses a lithium secondary battery in which a lower crystalline or amorphous intermetallic compound including an element selected from the group containing of Al, Ge, Pb, Si, Sn, and Zn is used for a negative electrode. The lithium secondary battery was described to have high capacity and an excellent cycle characteristic. However, it is actually very difficult to lower-crystallize the intermetallic compound or make it amorphous. Accordingly, it is difficult for the lithium secondary battery to secure high-capacity and long cycle-life due to the aforementioned technological problem.

In particular, Sn, Si, and SnO₂-based negative active materials have over twice larger capacity than a conventional negative electrode. However, the SnO or SnO₂-based negative active material not only has large irreversible capacity, at over 65% of the entire capacity, but it also has poor cycle life characteristics.

### SUMMARY OF THE INVENTION

One embodiment of the present invention provides a negative active material for a lithium secondary battery that is capable of improving high-rate performance.

Another embodiment of the present invention provides a lithium secondary battery that includes a negative electrode including the above negative active material.

According to one embodiment of the present invention, provided is a negative active material for a lithium secondary battery that includes a core material including an inorganic particulate that can form a compound by a reversible reaction with lithium, and a surface-treatment layer disposed on the surface of the core material. The surface-treatment layer includes a metal with electronic conductivity of 10³ S/cm or more.

According to another embodiment of the present invention, provided is a method that includes preparing a first solution including an inorganic particulate that can reversibly react with lithium to form a compound, preparing a second solution including a metal material with electronic conductivity of more than 10³ S/cm, preparing a mixed solution by mixing the first and second solutions, and forming a surface-treatment layer on the surface of the inorganic particulate by adding a reducing agent to the mixed solution.

The present invention also provides a lithium secondary battery including the negative active material.

### BRIEF DESCRIPTION OF THE DRAWINGS

FIG. 1 is a schematic view showing a lithium secondary battery according to one embodiment of the present invention.

FIG. 2 shows X-ray diffraction patterns of negative active materials according to Example 1 and Comparative Examples 1 and 2.

FIG. 3A is an electron microscope photograph of the negative active material according to Example 1.

FIG. 3B is a ×200,000 enlarged view of the negative active material of FIG. 3A.

FIG. 4A is an electron microscope photograph of the negative active material according to Comparative Example 2.

FIG. 4B is a ×200,000 enlarged view of the negative active material of FIG. 4A.

FIG. 5A is a graph showing charge and discharge characteristics of the battery cell according to Example 5.

FIG. 5B is a graph showing charge and discharge characteristics of the battery cell according to Comparative Example 3.

### DETAILED DESCRIPTION OF THE INVENTION

Recently, development of negative active materials including various oxides such as a tin oxide, a lithium vanadium-based oxide, and the like has been researched. However, these materials have not yet accomplished satisfactory battery performance as an oxide negative electrode, and require more future research.

Among the above oxide negative active materials, TiO₂-based negative active materials have a large and thereby decreased density of a substrate, resultantly deteriorating high-rate performance and capacity characteristics. Accordingly, TiO₂ has been suggested for use as nanotubes or nanorods. For example, when nanotubes with a TiO₂—B structure were used as a negative active material, it was reported to have an initial discharge capacity of 340 mAh/g and initial charge capacity of 200 mAh/g, and a capacity conservation rate against the initial capacity at 10 C of about 50% (Electrochem. Solid State Lett. 9, A139 2006). In addition, when anatase-type TiO₂ nanotubes were included as a negative active material, it was reported to have initial discharge capacity of 314 mAh/g and charge capacity of 248 mAh/g. However, it has a sharply-deteriorated capacity conservation rate at 5 C or more, and thereby a capacity conservation rate against the initial capacity of more than 40% (Electrochem. Solid State Lett. 8, A26 2005).

This problem is reported to be caused due to low electronic conductivity of TiO₂ itself.

Therefore, the present invention provides a negative active material prepared by surface-treating an inorganic particulate that is capable of forming a compound by a reversible reaction with lithium and a metal having electronic conductivity of more than 10³ S/cm, so that it can remarkably improve high-rate performance at more than 10 C, even if a conductive agent is included in a small amount.

The negative active material according to one embodiment of the present invention includes a core material including an inorganic particulate that is capable of forming a compound by a reversible reaction with lithium, and a surface-treatment layer disposed on the surface of the core material. The surface-treatment layer includes a metal having electronic conductivity of 10³ S/cm or more.

The core material is an inorganic particulate that is capable of forming a compound by a reversible reaction with lithium, and in particular it may be selected from the group consisting of a vanadium oxide, a lithium vanadium oxide, SiOₓ (0<x<2), TiO₂, SnO₂, and mixtures thereof. It may appropriately include TiO₂, and in particular anatase-type TiO₂, since it can relatively intercalate more lithium ions and thereby accomplish higher capacity than rutile-type TiO₂.

The core material may have a long stick shape such as a nanotube, a nanorod, and the like.

In particular, the better the core material, the bigger aspect ratio it has. Herein, the aspect ratio indicates a ratio of a minor axis against a major axis. According to the embodiment of the present invention, it may have an aspect ratio of 5 to 1000, but according to another embodiment of the present invention, it can have an aspect ratio of 10 to 800. When the core material has an aspect ratio of less than 5, it may decrease a reaction area and thereby deteriorate high-rate performance. On the contrary, when it has an aspect ratio of more than 1000, it may have a negative reaction with an electrolyte, deteriorating initial reversible capacity.

The core material includes a surface-treatment layer including a metal with electronic conductivity on the surface.

The surface-treatment layer includes a metal with electronic conductivity of a predetermined level or more to improve low electronic conductivity of TiO₂. The metal may be any metal with electronic conductivity of more than 10³ S/cm, but according to another embodiment, it can have electronic conductivity of 10⁴ to 10⁶ S/cm or more. When the metal included in a surface-treatment layer has electronic conductivity of less than 10³ S/cm, it may deteriorate high-rate performance.

The metal is selected from the group consisting of Sn, Si, Ti, Ge, Pb, Bi, Sb, Ga, and combinations thereof. However, according to another embodiment, it is selected from the group consisting of Sn, Ga, Sb, and combinations thereof.

Further, the surface-treatment layer including the metal is disposed to be 2 to 20 nm thick on the surface of a core material. However, according to another embodiment, it may be 2 to 10 nm thick. When the surface-treatment layer is less than 2 nm thick, it may have little effect. On the contrary, when it is more than 20 nm thick, TiO₂ may be included in a relatively insufficent amount therein.

According to another embodiment of the present invention, provided is a method of preparing a negative active material as follows: preparing a first solution including an inorganic particulate that can form a compound by a reversible reaction with lithium (S1); preparing a second solution including a metal material with electronic conductivity of more than 10³ S/cm (S2); preparing a mixed solution by mixing the first and second solutions (S3); and disposing a surface-treatment layer on the surface of the inorganic particulate by adding a reducing agent to the mixed solution (S4).

Specifically, the first solution is prepared to include an inorganic particulate that can form a compound by a reversible reaction with lithium (S1).

The inorganic particulate is the same as aforementioned, and can be directly prepared or procured commercially. When it is directly prepared, it has no particular limit in preparing method.

For example, nanotube-type TiO₂ can be prepared by dissolving anatase TiO₂ powder in a base solvent such as NaOH, KOH, and the like, reacting the solution at a temperature of 100 to 200° C., or 120 to 150° C. according to another embodiment, then adding an acid such as hydrochloric acid and the like when the reaction is complete to gain a precipitate, drying the precipitate, and then heat-treating it at 150 to 400° C., or 150 to 300° C. according to another embodiment. Herein, when the reaction temperature is set at lower than 120° C. or higher than 150° C., the TiO₂ cannot have a tube shape.

In addition, when the precipitate is heat-treated at a temperature of lower than 150° C., it is difficult for it to be shaped as a tube. On the contrary, when treated at a temperature of higher than 400° C., TiO₂ nanoparticles may be clustered rather than shaped as a tube.

Hereinafter, a method of preparing a negative active material is illustrated in more detail. First of all, a first solution is prepared by dissolving TiO₂ that is pretreated to have a predetermined shape in a solvent.

The solvent may be selected from the group consisting of water, alcohol, ether, and a mixture thereof. According to another embodiment, it may include an ether such as dimethoxyethane. The alcohol may include a lower alcohol of C1 to C4 selected from the group consisting of methanol, ethanol, isopropanol, and combinations thereof.

Herein, the method may additionally include a well-known agitation process such as an ultrasonic treatment to promote dissolution of the solution.

On the other hand, a second solution is prepared by dissolving a metal material with electronic conductivity of more than 10³ S/cm (S2) in a solvent.

The metal material is the same as aforementioned, and is selected from the group consisting of a chloride of a metal with electronic conductivity of more than 104 S/cm, a hydroxide, an oxyhydroxide, a nitrate, a carbonate, an acetate, an oxalate, a citrate, and combinations thereof, but is not limited thereto. In particular, it may include a chloride including a metal selected from the group consisting of Sn, Si, Ti, Ge, Pb, Bi, Sb, Ga, and combinations thereof, a hydroxide, an oxyhydroxide, a nitrate, a carbonate, an acetate, an oxalate, a citrate, and combinations thereof.

The solvent may be selected from the group consisting of water, alcohols, ethers, or a mixture thereof, but according to another embodiment, it may include ethers such as dimethoxyethane. The alcohol may appropriately be a C1 to C4 lower alcohol selected from the group consisting of methanol, ethanol, isopropanol, and combinations thereof.

The second solution may include a metal material in a concentration of 0.05 to 0.5M, or in a concentration of 0.1 to 0.3M according to another embodiment. When the metal material is included in a concentration of less than 0.05M, it is difficult to be uniformly coated. On the contrary, when included in a concentration of more than 0.3M, it may cause a coating layer to be too thick, resulting in deteriorating the amount of TiO₂.

Next, the first solution is mixed with the second solution, preparing a mixed solution (S3).

When the first solution is mixed with the second solution, they should be mixed in a mole ratio of 0.9:0.1 to 0.7:0.3 between the inorganic particulate and metal, but according to another embodiment, they are mixed in a mole ratio of 0.9:0.1 to 0.8:0.2 between the inorganic particulate and metal. When the metal is included at substantially more than the inorganic particulate beyond the above mole ratio, it may deteriorate capacity. On the other hand, when the inorganic particulate is included at substantially more than the metal beyond the above mole ratio, it may deteriorate the high power characteristic.

Then, a surface-treatment layer is disposed on the surface of an inorganic particulate by adding a reducing agent to the mixed solution (S4).

The reducing agent may include a compound such as NaBH₄, hydrazine, and the like.

The reducing agent may be included in an amount of 0.1 to 3 moles based on 1 mole of a metal material. However, it may be included in an amount of 0.1 to 1 mole according to another embodiment. When the reducing agent is included in an amount of less than 0.01 mole, it may deteriorate reduction capability. On the other hand, when it is included in an amount of 3 moles, it can be economically inefficient and have a negative reaction.

Then, the surface-treated inorganic particulate is washed and dried to prepare a negative active material according to the present invention.

The drying process has no particular limit in the present invention, but can be appropriately performed under vacuum. In addition, it can be performed at a temperature of 80 to 150° C.

According to the embodiment of the present invention, a negative active material includes a metal with electronic conductivity of a predetermined level on the surface thereof, and can thereby accomplish excellent high-rate performance. Accordingly, when it is used to fabricate an electrode, it can reduce the amount of a conductive agent.

According to still another embodiment of the present invention, a lithium secondary battery including the negative active material is provided.

The lithium secondary battery includes a negative electrode including a negative active material, a positive electrode, and an electrolyte inserted therebetween. Herein, the negative active material is the same as aforementioned.

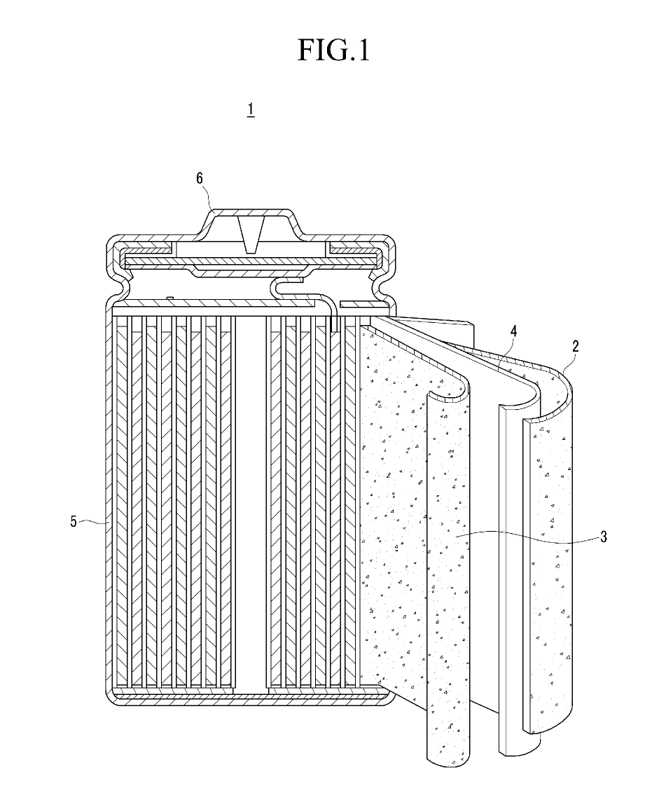

FIG. 1 is an exploded perspective view of a lithium secondary battery according to one embodiment of the present invention. Referring to FIG. 1 for further specific illustration, a lithium secondary battery 1 includes a negative electrode 2, a positive electrode 3, a separator 4 positioned therebetween, an electrolyte (not shown) impregnating the negative electrode 2, the positive electrode 3, and the separator 4, a battery container 5, and a sealing member 6 sealing the battery container 5.

The negative electrode 2 and the positive electrode 3 can be fabricated by disposing a composition for a negative electrode or a positive active material respectively including a negative active material or positive active material on a current collector into a film-shaped active mass.

The active mass can be formed by directly coating the composition for a positive active material or a negative active material on a current collector and thereafter drying it, or casting the composition for a positive active material or a negative active material on a separate supporter and then peeling it off from the supporter and thereafter laminating the film peeled off from the supporter on a current collector.

In addition, the composition for a negative active material or a positive active material can be prepared by dissolving or dispersing a negative active material or a positive active material, a binder, and a conductive agent into a solvent.

Herein, the negative active material is the same as aforementioned.

The positive active material has no particular limit in the present invention, but may include a compound that can intercalate/deintercalate lithium ions. Representatively, the positive active material may include a metal oxide, a lithium composite metal oxide, a lithium composite metal sulfide, a lithium composite metal nitride, and the like.

The binder is a chemical material that is stable in an electrochemical reaction, and plays a role of buffering against conversion of active materials into a paste, adhesion between active materials, mutual adhesion of an active material to a current collector, and expansion and contraction of an active material. The binder may be selected from the group consisting of a water-soluble organic polymer, a non-water-soluble organic polymer, and combinations thereof. The water-soluble organic polymer may include at least one selected from the group consisting of polyvinyl alcohol, carboxylmethyl cellulose, methyl cellulose, ethyl cellulose, isopropyl cellulose, hydroxymethyl cellulose, hydroxyethyl cellulose, hydroxypropylmethyl cellulose, cyanoethyl cellulose, ethyl-hydroxyethyl cellulose, polyoxyethylene, poly N-vinylpyrrolidone, polyvinylacetate, and combinations thereof. The non-water-soluble organic polymer may include at least one selected from the group consisting of polyvinylfluoride, polyvinylidenefluoride, tetrafluoroethylene polymers, trifluoroethylene polymers, difluoroethylene polymers, ethylene-tetrafluoroethylene copolymers, tetrafluoroethylene-hexafluoropropylene copolymers, tetrafluoroethylene-perfluoroalkylvinylether copolymers, trifluoroethylene chloride polymers, polyethylene, polypropylene, and combinations thereof.

The conductive agent is used to impart conductivity to an electrode, but does not cause any chemical change. Accordingly, it may include any electronic conductive material. It may include an amorphous carbon such as acetylene black, ketjen black, and the like, a carbon material such as graphite-structured carbon and the like, or a metal material such as nickel, copper, silver, titanium, platinum, aluminum, cobalt, iron, chromium, and the like. This conductive agent can have various shapes such as a sphere, a flask, a filament, a fiber, a spike, or a needle shape. When conductive agents respectively having two different shapes are mixed, they can further enhance tap density.

In addition, the solvent may include N-methylpyrrolidone (NMP), acetone, tetrahydrofuran, decane, and the like, but according to another embodiment, it may include N-methylpyrrolidone.

Herein, composition of a positive active material, a negative active material, a conductive agent, a binder, and a solvent are appropriately selected from the above ranges to prepare an electrode by those who have common knowledge in this related field.

The current collector plays a role of collecting electrons produced through electrochemical reaction of an active material and supplying electrons required for the electrochemical reaction. This current collector may be copper or stainless steel treated with carbon, nickel, or titanium on the surface as well as stainless steel, aluminum, nickel, copper, titanium, carbon, conductive resin, and the like. In particular, a positive electrode may include a current collector made of an aluminum material, while a negative electrode may include a current collector made of a copper material.

The electrolyte plays a role of transferring lithium ions at positive and negative electrodes, and may include a non-aqueous electrolyte, a well-known solid electrolyte, or the like. For example, the non-aqueous electrolyte may be a solution prepared by dissolving a lithium salt in a non-aqueous organic solvent.

The lithium salt may be selected from the group consisting of LiClO₄, LiBF₄, LiPF₆, LiAlCl₄, LiSbF₆, LiSCN, LiCl, LiCF₃SO₃, LiCF₃CO₂, Li(CF₃SO₂)₂, LiAsF₆, LiN(CF₃SO₂)₂, LiB₁₀Cl₁₀, lower aliphatic lithium carboxylate, LiCl, LiBr, LiI, chloroborane lithium, and combinations thereof.

The non-aqueous organic solvent acts to transfer ions and includes, but is not limited to, cyclic carbonates such as ethylene carbonate, propylene carbonate, butylenes carbonate, vinylene carbonate, and so on; linear carbonates such as dimethyl carbonate, methylethyl carbonate, diethyl carbonate, and so on; esters such as methyl acetate, ethyl acetate, propyl acetate, methyl propionate, ethyl propionate, γ-butyrolactone, and so on; ethers such as 1,2-dimethoxyethane, 1,2-diethoxyethane, tetrahydrofuran, 1,2-dioxane, 2-methyltetrahydrofuran, and so on; nitriles such as acetonitrile; and amides such as dimethylformamide. They can be used singularly or in combination. In particular, the solvent may be a mixed solvent including cyclic carbonate and linear carbonates.

The solid electrolyte is selected from the group consisting of Li₄SiO₄, Li₄SiO₄—LiI—LiOH, Li₂SiS₃, Li₃PO₄—Li₂S—SiS₂, phosphorous sulfide compounds, polyethylene oxide (PEO), polyacrylonitrile (PAN), polymethylmethacrylate (PMMA), polyvinylidene fluoride (PVDF), and combinations thereof.

According to the embodiment of the present invention, the lithium secondary battery 1 includes the separator 4 cutting off electronic conductivity and conducting lithium ions between the negative electrode 2 and the positive electrode 3. The separator 4 plays an important role of separating positive and negative electrodes and improving stability. The separator may include anything as long as it is commonly used in a lithium secondary battery, for example polyethylene, polypropylene, polyvinylidene fluoride, or multilayers thereof.

According to the embodiment of the present invention, a lithium secondary battery can have various shapes such as a coin, a button, a sheet, a stack, a cylinder, a plate, a prism, and the like, and can accordingly be variously designed for appropriate applications.

In addition, the lithium secondary battery of the present invention can be used for a portable information terminal, a portable electronic device, a small domestic electric power storage device, an electric two-wheeler, an electric vehicle, a hybrid electric vehicle, and the like.

The following examples illustrate the present invention in more detail. These examples, however, should not in any sense be interpreted as limiting the scope of the present invention.

### EXAMPLE 1

4 g of anatase TiO₂ powder was completely dissolved in 70 ml of NaOH. The resulting solution was treated with ultrasonic waves for 30 minutes. Then, the solution was put in a TEFLON (tetrafluoroethylene) bottle and then reacted at 150° C. for 48 hours. When the reaction was complete, it was allowed to stand in 0.1M of HCl for 1 hour and thereafter washed with water and dried at 150° C. The dried powder was heat-treated at 400° C. for 3 hours to synthesize anatase-type TiO₂ nanotubes (aspect ratio: 100). Then, 2 g of the powder was put in 100 ml of 1,2-dimethoxyethane, and thereafter they were mixed at 200° C. at a speed of 100 rpm, preparing a first solution including TiO₂.

On the other hand, a second solution was prepared by dissolving 1.8 ml of SnCl₄ in 30 ml of 1,2-dimethoxyethane. This second solution was mixed with the first solution including TiO₂, preparing a mixed solution.

Then, 0.8 g of NaBH₄ powder as a reducing agent was added to the mixed solution. The acquired product from the above reaction was respectively washed with acetone and water three times and vacuum-dried at 80° C., preparing a negative active material.

### EXAMPLE 2

A negative active material was prepared according to the same method as in Example 1, except for respectively using 1.8 ml of SnCl₄ and 1.2 g of NaBH₄ powder.

### EXAMPLE 3

A negative active material was prepared according to the same method as in Example 1, except for respectively using 3 ml of SnCl₄ and 1.7 g of NaBH₄ powder.

### EXAMPLE 4

A negative active material was prepared according to the same method as in Example except for including a first solution including SiOₓ (0<x<2) prepared by adding 2 g of SiOₓ (0<x<2) powder (aspect ratio=100) to 100 ml 1,2-dimethoxyethane and then mixing them at 200° C. at a speed of 100 rpm.

### COMPARATIVE EXAMPLE 1

4 g of anatase TiO₂ powder was completely dissolved in 70 ml of NaOH. The resulting solution was treated with ultrasonic waves for 30 minutes. Then, this solution was put in a TEFLON (tetrafluoroethylene) bottle and reacted at 150° C. for 48 hours. When the reaction was complete, the resulting mixture was allowed to stand in 0.1M of HCl for 1 hour and then washed with water and dried at 150° C. The dried powder was heat-treated at 150° C. for 3 hours to synthesize anatase-type TiO₂ nanotubes (aspect ratio: 100).

### COMPARATIVE EXAMPLE 2

4 g of anatase TiO₂ powder was dissolved in 70 ml of NaOH. The resulting solution was treated with ultrasonic waves for 30 minutes. Then, this solution was put in a TEFLON (tetrafluoroethylene) bottle and reacted at 150° C. for 48 hours. When the reaction was complete, it was allowed to stand in 0.1M of HCl for 1 hour. The product was washed with water and dried at 150° C. The dried powder was heat-treated at 300° C. for 3 hours to synthesize anatase-type TiO₂ nanotubes (aspect ratio=100).

### EXPERIMENTAL EXAMPLE 1

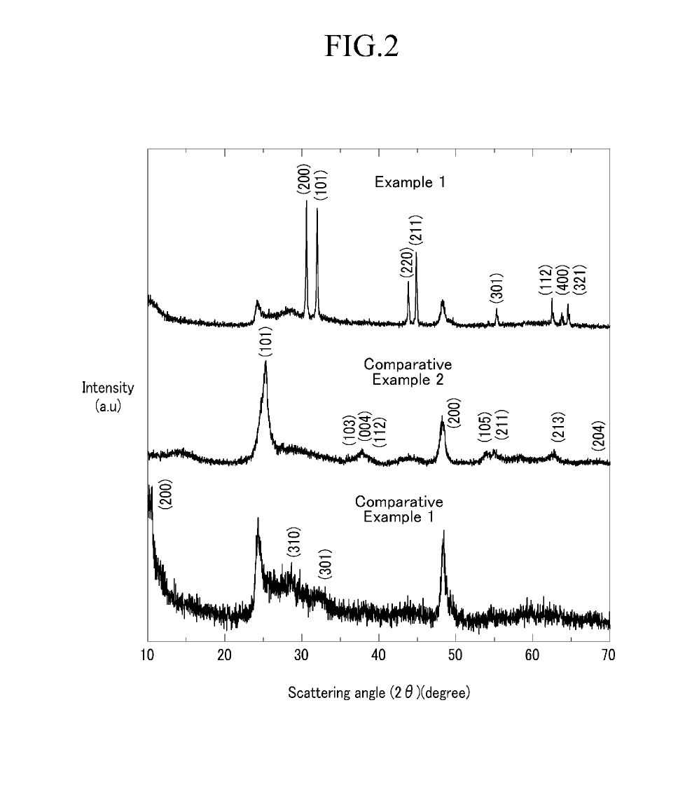

X-ray diffraction analysis was performed on the negative active materials according to Example 1 and Comparative Examples 1 and 2. The results are shown in FIG. 2.

FIG. 2 shows X-ray diffraction patterns of the negative active materials according to Example 1 and Comparative Examples 1 and 2.

As shown in FIG. 2, TiO₂ heat-treated at 150° C. according to Comparative Example 1 turned out to not have an anatase phase. On the contrary, TiO₂ treated at 300° C. according to Comparative Example 2 turned out to be completely converted into an anatase phase. In addition, when the TiO₂ powder heat-treated at 400° C. as in Example 1 was coated with Sn, it turned out to be completely converted into an anatase phase. Accordingly, FIG. 2 simultaneously shows peaks of TiO₂ conversion into anatase and typical peaks of Sn.

### EXPERIMENTAL EXAMPLE 2

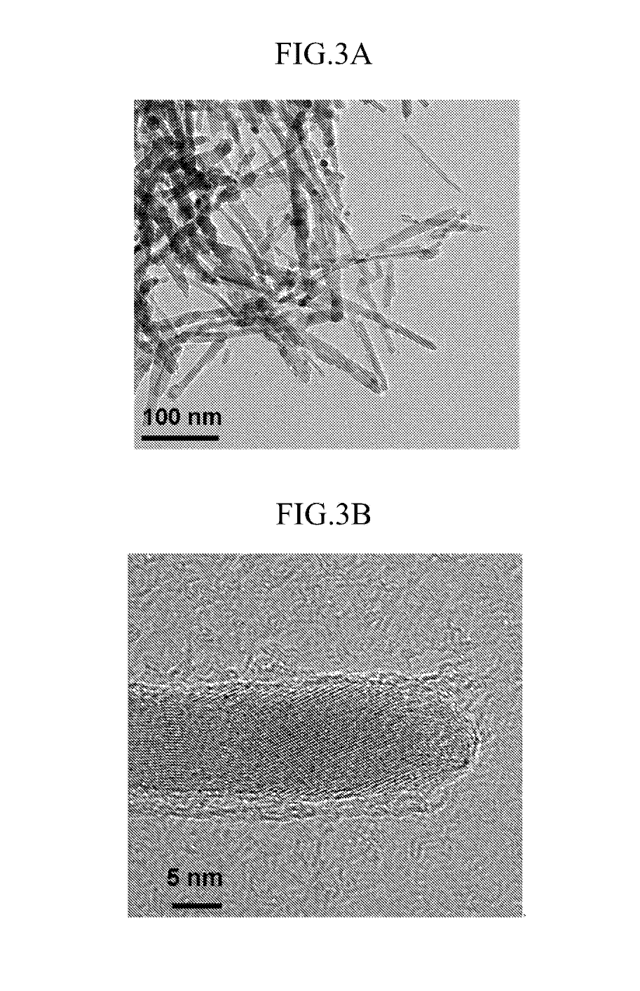

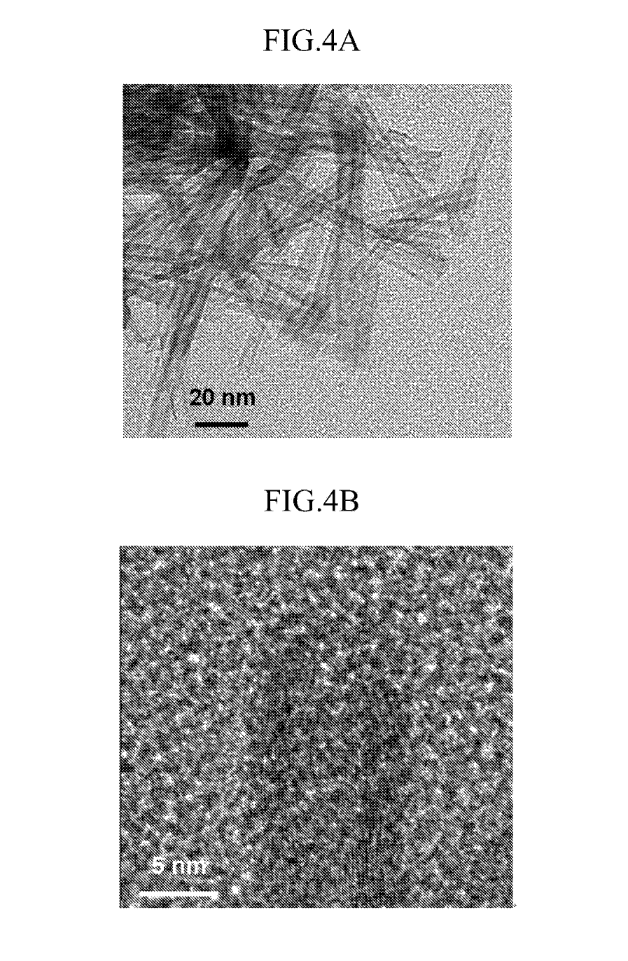

Then, the negative active materials according to Example 1 and Comparative Example 2 were examined with a microscope. The results are shown in FIGS. 3A, 3B, 4A, and 4B.

FIG. 3A shows an electron microscope photograph of the negative active material according to Example 1, and FIG. 3B shows a 200,000-times enlarged view of the negative active material of FIG. 3A. FIG. 4A shows the electron microscope photograph of the negative active material according to Comparative Example 2. FIG. 4B shows a 200,000-times enlarged view of the negative active material of FIG. 4A.

As shown in FIGS. 3A and 3B, the anatase-type TiO₂ according to Example 1 turned out to be a nanotube with a diameter of 13 nm. On the contrary, as shown in FIGS. 4A and 4B, the anatase-type TiO₂ according to Comparative Example 2 turned out to be a hollow nanotube with a diameter of 10 nm. Comparing FIGS. 3A and 3B with 4A and 4B, the negative active material according to Example 1 did not have a hollow tube shape, since it was uniformly surface-treated with Sn. In addition, the negative active material of Example 1 had a 3 nm bigger tube diameter than that of Comparative Example 2. Based on this result, the Sn surface-treatment layer can be calculated to be 3 nm-thick.

The negative active materials according to Examples 2 and 3 were examined with an electronic microscope in the same method.

As a result, they respectively turned out to have 4.2 nm and 5 nm-thick Sn surface-treatment layers.

### EXAMPLE 5

The negative active material of Example 1 was mixed with Super-P as a conductive agent), and polyvinylidene fluoride as a binder in a weight ratio of 80/10/10 to prepare a composition for a negative electrode. The composition for a negative electrode was coated to be 300 μm thick on an Al-foil, and then dried at 130° C. for 20 minutes. Next, it was compressed with a pressure of 1 ton, gaining a negative electrode substrate.

Then, the negative electrode substrate was used with lithium metal as a counter electrode to fabricate a coin-type cell. Herein, an electrolyte for the cell was prepared by dissolving 1M of LiPF₆ in a solvent including ethylene carbonate (EC) and dimethyl carbonate (DMC) in a volume ratio of 1:1.

### EXAMPLE 6

A coin-type cell was fabricated according to the same method as in Example 5, except for using the negative active material of Example 2.

### EXAMPLE 7

A coin-type cell was fabricated according to the same method as in Example 5, except for using the negative active material of Example 3.

### EXAMPLE 8

A coin-type cell was fabricated according to the same method as in Example 5, except for using the negative active material of Example 4.

### COMPARATIVE EXAMPLE 3

The negative active material of Comparative Example 2 was mixed with Super-P as a conductive agent and polyvinylidene fluoride as a binder in a weight ratio of 70/20/10 to prepare a composition for a negative electrode. The composition for a negative electrode was coated to be 300 μm thick on an Al-foil and dried at 130° C. for 20 minutes. Then, it was compressed with a pressure of 1 ton, preparing a negative electrode substrate.

The negative electrode substrate was used with a lithium metal as a counter electrode to fabricate a coin-type cell. Herein, an electrolyte for the coin-type cell was prepared by dissolving 1M of LiPF₆ in a solvent including ethylene carbonate (EC) and dimethyl carbonate (DMC) in a volume ratio of 1:1.

### COMPARATIVE EXAMPLE 4

A coin-type cell was fabricated according to the same method as in Comparative Example 3, except for using a composition for a negative electrode prepared by mixing the negative active material of Comparative Example 2, Super-P as a conductive agent, and polyvinylidene fluoride as a binder in a weight ratio of 80/10/10.

### EXPERIMENTAL EXAMPLE 3

Half of the coin-type cells fabricated according to Examples 5 to 7 and Comparative Examples 3 and 4 were evaluated regarding rate charge and discharge capability depending on various rates of 1 to 2.5V. The results are shown in the following Table 1. Herein, the rate charge and discharge capability was evaluated for 1 cycle.

The capacity detention was calculated as a percentage of the value gained by dividing discharge capacity at first charge and discharge at 20 C with discharge capacity at first charge and discharge at 0.1 C.

TABLE 1

| | | | | | | | Capacity |
|---|---|---|---|---|---|---|---|
| | Discharge capacity (mAh/g) | | | | | | retention |
| | 0.1 C | 0.5 C | 1 C | 5 C | 10 C | 20 C | (%) |
| Comparative | 300 | 245 | 230 | 203 | 180 | 163 | 54% |
| Example 3 | | | | | | | |
| Comparative | 300 | 245 | 220 | 193 | 170 | 150 | 50% |
| Example 4 | | | | | | | |
| Example 5 | 222 | 198 | 189 | 184 | 180 | 176 | 79% |
| Example 6 | 215 | 196 | 185 | 180 | 174 | 172 | 80% |
| Example 7 | 212 | 196 | 180 | 172 | 170 | 168 | 86% |

As shown in Table 1, the coin-type cells of Comparative Examples 3 and 4, which included TiO₂ without a surface-treatment layer as a negative active material, respectively had low capacity retentions of 54% and 50%. However, the coin-type cell of Examples 5 to 7, which included an active material with a Sn surface-treatment layer, had high capacity retention of at least 79%.

### EXPERIMENTAL EXAMPLE 4

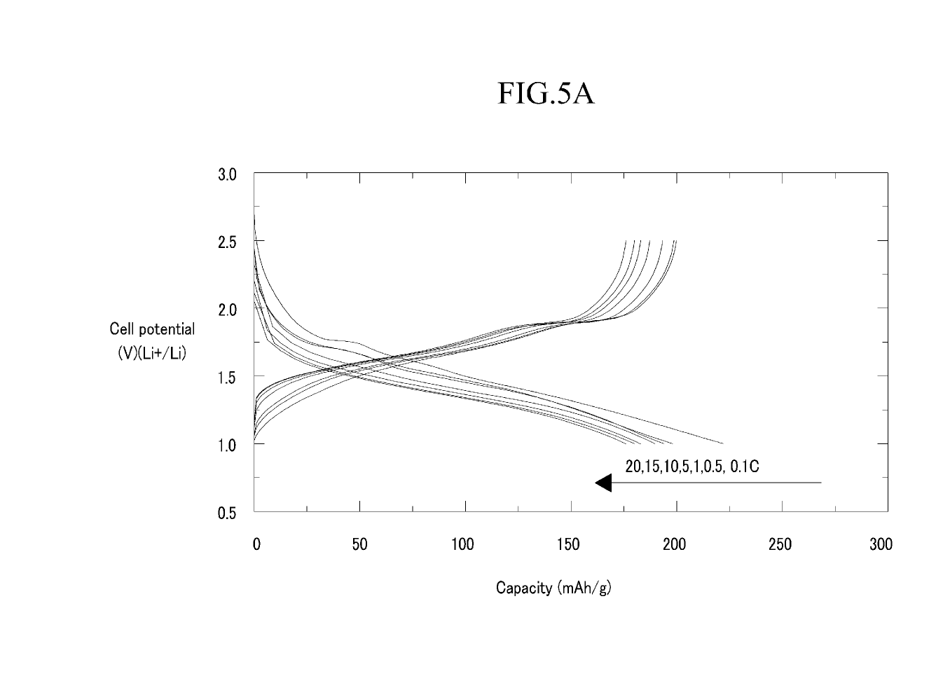

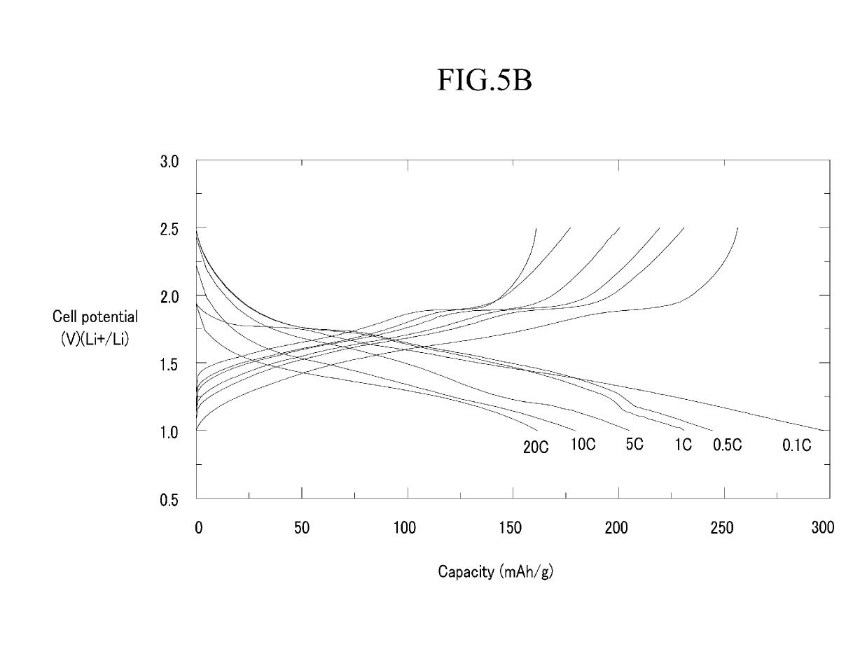

The charge and discharge experiment was performed on the cells of Example 5 and Comparative Example 3 within a voltage range of 1 to 2.5V at a room temperature of 30° C. to examine their charge and discharge characteristics depending on charge and discharge speed. The results are shown in FIGS. 5A and 5B.

FIG. 5A shows a charge and discharge curved line of the cell according to Example 5, while FIG. 5B shows a charge and discharge curved line of the cell according to Comparative Example 3.

As shown in FIGS. 5A and 5B, the cell of Example 5, which included an active material with a Sn surface-treatment layer, had a very low irreversible capacity rate of 10% between initial discharge capacity of 222 mAh/g and charge capacity of 199 mAh/g. On the contrary, the cell of Comparative Example 3 had a very high irreversible capacity rate of 14% between initial discharge capacity of 296 mAh/g and charge capacity of 256 mAh/g.

Therefore, the negative active material of the present invention has excellent electronic conductivity and can thereby improve high-rate performance of a lithium secondary battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative active material for a lithium secondary battery, comprising:
a core material including an inorganic particulate that is capable of forming a compound by a reversible reaction with lithium; and
a surface-treatment layer disposed on the surface of the core material,
wherein the surface-treatment layer includes a metal having electronic conductivity of 10³ S/cm or more.

2. The negative active material of claim 1, wherein the metal has electronic conductivity of 10⁴ to 10⁶ S/cm.

3. The negative active material of claim 1, wherein the metal is selected from the group consisting of Sn, Si, Ti, Ge, Pb, Bi, Sb, Ga, and combinations thereof.

4. The negative active material of claim 1, wherein the surface-treatment layer is 2 to 20 nm thick.

5. The negative active material of claim 1, wherein the inorganic particulate that can form a compound by a reversible reaction with lithium is selected from the group consisting of vanadium oxide, lithium vanadium oxide, SiOₓ (0<x<2), TiO₂, SnO₂, and mixtures thereof.

6. The negative active material of claim 1, wherein the inorganic particulate that can form a compound by a reversible reaction with lithium is anatase-type TiO₂.

7. The negative active material of claim 1, wherein the core material is selected from the group consisting of nanotubes, nanorods, and combinations thereof.

8. The negative active material of claim 1, wherein the core material has an aspect ratio of 5 to 10,000, when the aspect ratio indicates a ratio of a minor axis vs. a major axis.

9. A method of preparing a negative active material comprising:
preparing a first solution containing an inorganic particulate that can form a compound by a reversible reaction with lithium;
preparing a second solution containing a metal material with electronic conductivity of 10³ S/cm or more;
preparing a mixed solution by mixing the first and second solutions; and
forming a surface-treatment layer on the surface of the inorganic particulate by adding a reducing agent to the mixed solution.

10. The method of claim 9, wherein the inorganic particulate that can form a compound by a reversible reaction with lithium is selected from the group consisting of vanadium oxide, lithium vanadium oxide, SiOₓ(0<x<2), TiO₂, SnO₂, and mixtures thereof.

11. The method of claim 9, wherein the inorganic particulate that can form a compound by a reversible reaction with lithium is anatase-type TiO₂.

12. The method of claim 9, wherein the metal material is selected from the group consisting of a chloride of a metal selected from the group consisting of Sn, Si, Ti, Ge, Pb, Bi, Sb, Ga, and combinations thereof, a hydroxide, an oxyhydroxide, a nitrate, a carbonate, an acetate, an oxalate, a citrate, and combinations thereof.

13. The method of claim 9, wherein the second solution comprises the metal material in a concentration of 0.05 to 0.5M.

14. The method of claim 9, wherein the first and second solutions are mixed to comprise the inorganic particulate and the metal in a mole ratio of 0.9:0.1 to 0.7:0.3.

15. The method of claim 9, wherein the reducing agent is selected from the group consisting of NaBH₄, hydrazine, and mixtures thereof.

16. The method of claim 9, wherein the reducing agent is used in an amount of 0.1 to 3 moles based on 1 mole of a metal material.
A lithium secondary battery comprising:
a positive electrode comprising a positive active material;
a negative electrode comprising a negative active material according to claim 1; and
an electrolyte inserted therebetween.
